(19) United States
(12) Patent Application Publication
(10) Pub. No.: US 2024/0168124 A1
(43) Pub. Date: May 23, 2024

(54) USER DEVICE LOCATION ESTIMATION

(71) Applicant: NOKIA SOLUTIONS AND NETWORKS OY, Espoo (FI)

(72) Inventor: Lei NIU, Chengdu (CN)

(73) Assignee: NOKIA SOLUTIONS AND NETWORKS OY, Espoo (FI)

(21) Appl. No.: 18/552,231

(22) PCT Filed: Mar. 24, 2021
(86) PCT No.: PCT/CN2021/082816

§ 371 Date: Sep. 25, 2023

(51) Int. Cl. G01S 5/02; G01S 5/00; H04B 17/318

(52) U.S. Cl. CPC G01S 5/02525; G01S 5/0063; H04B 17/328

(57) ABSTRACT

A method, apparatus and computer program is described comprising: collecting mobile communication fingerprint data for signals between a user device and a plurality of communication nodes of a mobile communication system; organising the collected data into a feature matrix, wherein the feature matrix includes a user device location associated with each set of fingerprint data; generating a binomial expression of the system based on the collected data; processing the binomial expression (e.g. using a factorisation machine) to generate a reduced dimension binomial expression model; and calculating gradients and updating parameters of the reduced dimensional binomial expression model based on said gradients.

### FIELD

The present specification relates to location estimation, such as estimating a location of a user device within a mobile communication system based on fingerprint data.

### BACKGROUND

Fingerprint positioning is a process that makes use of a range of mobile communication data that is applied to a model to generate a predicted or estimated location. For example, a prediction or estimation of a location of a user device of a mobile communication system can be generated from mobile communication data associated with the user device. There remains a need for further developments in this field.

### SUMMARY

In a first aspect, this specification describes an apparatus comprising means for performing: collecting mobile communication fingerprint data for signals between a user device and a plurality of communication nodes (e.g. from multiple base stations) of a mobile communication system; organising the collected data into a feature matrix, wherein the feature matrix includes a user device location associated with each set of fingerprint data; generating a binomial expression of the system (e.g. in order to increase the number of features of the model) based on the collected data; processing the binomial expression using a factorisation machine (or some other means) to generate a reduced dimension binomial expression model; and calculating gradients and updating parameters of the reduced dimensional binomial expression model based on said gradients. The feature matrix may be stored at a location server (e.g. on the cloud). The user device location may be based on ground truth data.

The mobile communication fingerprint data may comprise one or more of: reference signal receiving power (RSRP), time of arrival (ToA) and angle of arrival (AoA) data at the user device. The RSRP data may be measured at the user device. The ToA and AoA data may be measured at a communication node or base station.

The user device location may be a discrete area, such as a “bin”. This may turn the classification into a multi-class classification problem.

The reduced dimension binomial expression model may comprise the binomial expression of the system factorised into an approximate product of two matrices.

The said gradients may be calculated using stochastic gradient descent.

The means for performing updating said parameters may update said parameters using a softmax cost function.

The means for updating said gradient updates said gradients until a defined condition (e.g. a defined performance level or a defined number of iterations) is reached.

Some example embodiments further comprise means for performing: determining whether a number of features in the feature matrix is above a first threshold level and, if so, using an alternative dimension reduction algorithm (such as PCA) instead of said factorisation machine.

Some example embodiments further comprise means for performing: determining whether a number of data points in the feature matrix is above a second threshold level and generating said binomial expression in the event that that the number of data points is above said second threshold level. If the number of data points is below said second threshold level, this may be indicative of an insufficient data case.

The said means may comprise at least one processor and at least one memory including computer program code. The at least one memory and the computer program code may be configured to, with the at least one processor, cause the performance of the apparatus.

In a second aspect, this specification describes a method comprising: collecting mobile communication fingerprint data for signals between a user device and a plurality of communication nodes of a mobile communication system; organising the collected data into a feature matrix, wherein the feature matrix includes a user device location associated with each set of fingerprint data; generating a binomial expression of the system based on the collected data; processing the binomial expression (e.g. using a factorisation machine) to generate a reduced dimension binomial expression model; and calculating gradients and updating parameters of the reduced dimensional binomial expression model based on said gradients. The feature matrix may be stored at a location server (e.g. on the cloud). The user device location may be based on ground truth data.

The reduced dimension binomial expression model may comprise the binomial expression of the system factorised into an approximate product of two matrices.

The said gradient updates may be updated until a defined condition (e.g. a defined performance level or a defined number of iterations) is reached.

Some example embodiments further: determining whether a number of features in the feature matrix is above a first threshold level and, if so, using an alternative dimension reduction algorithm (such as PCA) instead of said factorisation machine.

Some example embodiments further comprise: determining whether a number of data points of the features is above a second threshold level and generating said binomial expression in the event that that the number of data points is above said second threshold level. If the number of data points is below said second threshold level, this may be indicative of an insufficient data case.

In a third aspect, this specification describes an apparatus comprising means for performing: collecting mobile communication fingerprint data for signals between a user device and a plurality of communication nodes of a mobile communication system; and providing the fingerprint data to a model to generate an estimate of a location of the user device, wherein the model comprises a reduced dimensional binomial expression model. In the third aspect, the reduced dimensional binomial expression mode may be generated using a method as described above with reference to the second aspect.

In a fourth aspect, this specification describes a method comprising: collecting mobile communication fingerprint data for signals between a user device and a plurality of communication nodes of a mobile communication system; and providing the fingerprint data to a model to generate an estimate of a location of the user device, wherein the model comprises a reduced dimensional binomial expression model.

In a fifth aspect, this specification describes computer-readable instructions which, when executed by computing apparatus, cause the computing apparatus to perform (at least) any method as described with reference to the second or fourth aspects.

In a sixth aspect, this specification describes a computer-readable medium (such as a non-transitory computer-readable medium) comprising program instructions stored thereon for performing (at least) any method as described with reference to the second or fourth aspects.

In a seventh aspect, this specification describes an apparatus comprising: at least one processor; and at least one memory including computer program code which, when executed by the at least one processor, causes the apparatus to perform (at least) any method as described with reference to the second or fourth aspects.

In an eighth aspect, this specification describes a computer program comprising instructions for causing an apparatus to perform at least the following: collect mobile communication fingerprint data for signals between a user device and a plurality of communication nodes of a mobile communication system; organise the collected data into a feature matrix, wherein the feature matrix includes a user device location associated with each set of fingerprint data; generate a binomial expression of the system based on the collected data; process the binomial expression (e.g. using a factorisation machine) to generate a reduced dimension binomial expression model; and calculate gradients and updating parameters of the reduced dimensional binomial expression model based on said gradients.

In a ninth aspect, this specification describes a computer program comprising instructions for causing an apparatus to perform at least the following: collect mobile communication fingerprint data for signals between a user device and a plurality of communication nodes of a mobile communication system; and provide the fingerprint data to a model to generate an estimate of a location of the user device, wherein the model comprises a reduced dimensional binomial expression model.

In a tenth aspect, this specification describes: a location server (or some other means) for collecting mobile communication fingerprint data for signals between a user device and a plurality of communication nodes of a mobile communication system; a table (or some other means) for organising the collected data into a feature matrix, wherein the feature matrix includes a user device location associated with each set of fingerprint data; a processor (or some other means) for generating a binomial expression of the system based on the collected data; a factorisation machine (or some other means) for processing the binomial expression to generate a reduced dimension binomial expression model; and the processor (or some other means) for calculating gradients and updating parameters of the reduced dimensional binomial expression model based on said gradients.

In an eleventh aspect, this specification describes: an input (or some other means) for collecting mobile communication fingerprint data for signals between a user device and a plurality of communication nodes of a mobile communication system; and an output (or some other means) for providing the fingerprint data to a model to generate an estimate of a location of the user device, wherein the model comprises a reduced dimensional binomial expression model.

### BRIEF DESCRIPTION OF THE DRAWINGS

Example embodiments will now be described, by way of example only, with reference to the following schematic drawings, in which:

FIG. 1 is a block diagram of a system in accordance with an example embodiment;

FIG. 2 is a block diagram of a system in accordance with an example embodiment;

FIG. 3 shows a table used in an example embodiment;

FIGS. 4 to 7 are flow charts showing algorithms in accordance with example embodiments;

FIG. 8 is a block diagram of components of a system in accordance with an example embodiment; and

FIGS. 9A and 9B show tangible media, respectively a removable non-volatile memory unit and a compact disc (CD) storing computer-readable code which when run by a computer perform operations according to example embodiment.

### DETAILED DESCRIPTION

The scope of protection sought for various embodiments of the invention is set out by the independent claims. The embodiments and features, if any, described in the specification that do not fall under the scope of the independent claims are to be interpreted as examples useful for understanding various embodiments of the invention.

In the description and drawings, like reference numerals refer to like elements throughout.

Fingerprint positioning is a process that makes use of a range of mobile communication data, such as Reference Signal Receiving Power (RSRP), Time of Arrival (ToA), and Angle of Arrival (AoA), that is applied to a model (such as a machine-learned model) that provides a predicted or estimated location. For example, a prediction or estimate of a location of a user device of a mobile communication system can be generated from mobile communication data associated with the user device.

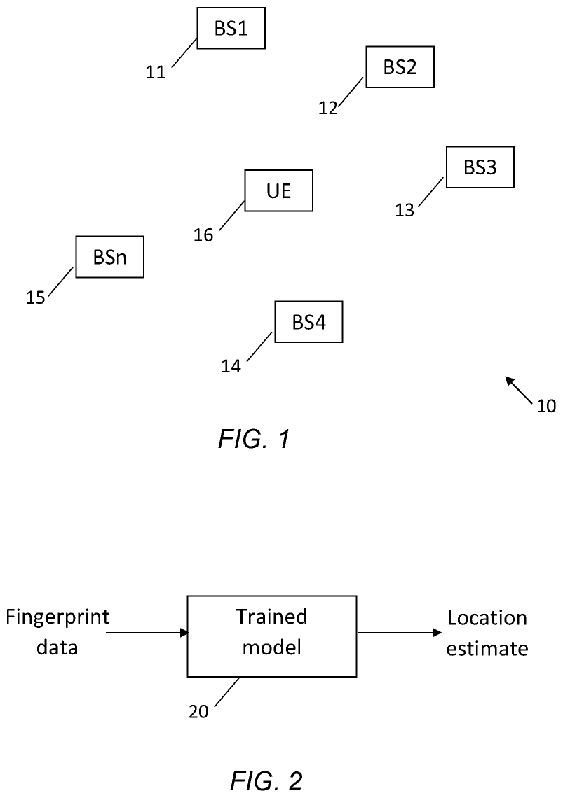

FIG. 1 is a block diagram of a system, indicated generally by the reference numeral 10, in accordance with an example embodiment.

The system 10 comprises a plurality of mobile communication nodes in the form of a first base station 11, a second base station 12, a third base station 13, a fourth base station 14 and an nth base station 15. A user device 16 is moving in the vicinity of the mobile communication nodes (and is shown, by way of example, close to the centre of the system 10).

FIG. 2 is a block diagram of a system in accordance with an example embodiment. The system comprise a trained model 20 that is configured to receive fingerprint data and to provide a location estimate (or prediction). For example, the model 20 may be used to provide an estimate of a location of the user device 16 in the system 10.

In an example use of the system, 20, fingerprint data may be collected for signals between the user device 16 and the plurality of base stations 11 to 15 such that the fingerprint data can be used by the model to generate the location estimate.

FIG. 3 shows a table, indicated generally by the reference numeral 30, used in an example embodiment.

The table 30 stores data samples for various data types associated with each of a plurality of base stations over time. Each row of the table 30 therefore represents a fingerprint. The fingerprint is associated with position data, such that the table 30 can be used for training purposes. For example, the position data can be used as ground truth data for a machine learning algorithm.

The example data types stored in the table 30 are reference signal receiving power (RSRP), time of arrival (ToA) and angle of arrival (AoA). RSRP may be measured at the user device, whilst ToA and AoA data may be measured at the respective base station. Of course, many other data types could be determined and stored instead of, or in addition to, some of the data shown in the table 30.

The serving area of a base station may be divided into discrete areas (such as “bins”). Accordingly, the table 30 may store the location of the user device as a bin reference. Storing a larger bin area, rather than detailed co-ordinates of a user device may reduce the complexity of a training algorithm.

If an area of which data samples are collected for populating the table 30 is increased, then the number of base stations from which data collated will generally increase. Increasing the number of data points that are available for use in training a model can increase the accuracy of that model. However, this is not always the case.

The use of RSRP, ToA and AoA data can cause problems in modelling since much of that data is highly correlated. Different samples of data relating to the same base station can highly correlated. Moreover, data from different base stations can be highly correlated. This can make modelling difficult. As discussed further below, one approach is to use a binomial modelling approach, which can be particularly effective when features for generating the model are highly correlated.

Increasing the coverage area can result in data sparsity. For example, reliable data may not be available in instances where the user device and a particular base station are separated by a significant distance. As discussed below, a binomial approach may be used in the modelling process. Data sparsity is known to hinder the performance of binomial modelling.

A further problem with binomial modelling relates to dimensionality. As the number of binomial expressions increases with the number of features, even a moderate feature size can render a model unmanageable.

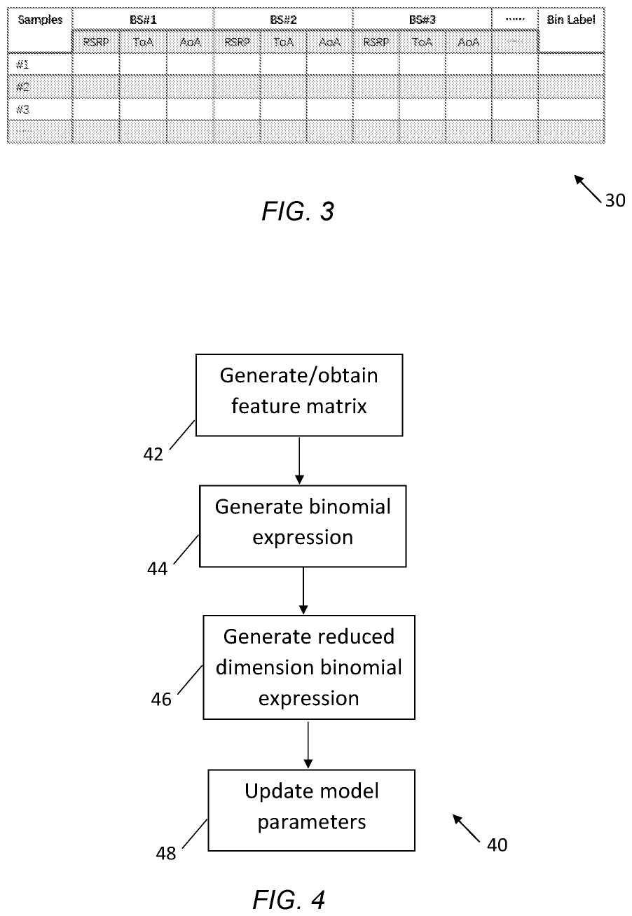

FIG. 4 is a flow chart showing an algorithm, indicated generally by the reference numeral 40, in accordance with an example embodiment.

The algorithm 40 starts at operation 42, where mobile communication fingerprint data is collected for signals between a user device and a plurality of communication nodes (e.g. from multiple base stations) of a mobile communication system. The fingerprint data may, for example, be stored on a location server (e.g. in the cloud).

The data collected in the operation 42 may be organised into a feature matrix having sets of fingerprint data and associated user device location data. The table 30 is an example output of such a feature matrix.

At operation 44, a binomial expression of the system is generated based on the collected data. The binomial expression may be used to increase the number of features in a model of the system.

At operation 46, a reduced dimension binomial expression model is generated. As discussed in detail below, the operation 46 may be implemented using a factorisation machine to process the binomial expression generated in the operation 44 to generate the reduced dimension binomial expression model.

Finally, at operation 48, gradients are generated (e.g. using stochastic gradient descent) and used to update parameters of the reduced dimensional binomial expression model, as discussed further below. The operation 48 may continue updating the gradient parameters until a defined condition (such as a defined performance level and/or a defined number of training iterations) has been reached.

In this way, a reduced dimension binomial expression model may be generated that can be used to model the system based on the feature matrix generated in operation 42. The model can then be used to generate position estimates/predictions based on newly obtained fingerprint data.

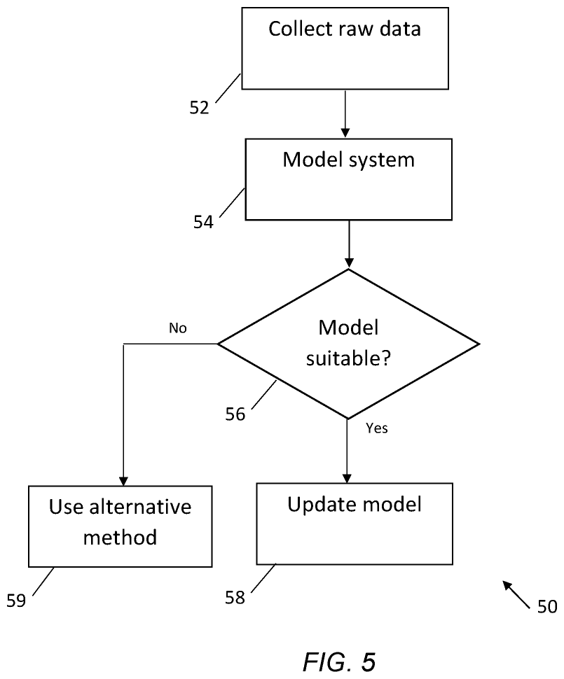

FIG. 5 is a flow chart showing an algorithm, indicated generally by the reference numeral 50, in accordance with an example embodiment. The algorithm 50 may be used in the generation of a model of the system 10 described above.

The algorithm 50 starts at operation 52, where raw data is collected. The raw data may include data such as Reference Signal Receiving Power (RSRP), Time of Arrival (ToA), and Angle of Arrival (AoA). As discussed above, RSRP may be measured at a user device (e.g. the user device 16), whilst ToA and AoA data may be measured at the respective base stations.

At operation 54, a model of the relevant system (e.g. the system 10) is generated.

At operation 56, a determination is made regarding whether the system model generated in the operation 54 is suitable. If so, the algorithm moves to operation 58, where the model is updated. If not, the algorithm moves to operation 59, where an alternative modelling method is used.

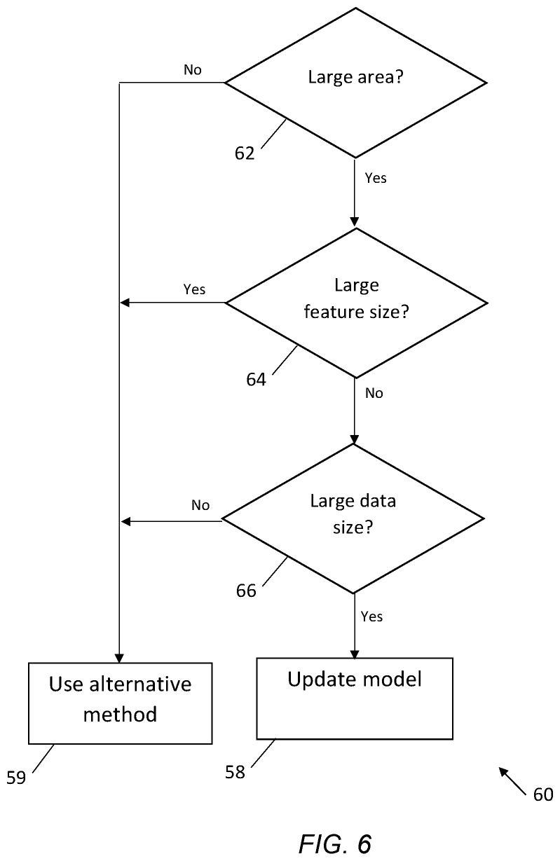

FIG. 6 is a flow chart showing an algorithm, indicated generally by the reference numeral 60, in accordance with an example embodiment. The algorithm 60 is an example implementation of the operation 56 of the algorithm 50 described above.

At operation 62, a determination is made regarding whether the area that is being modelled is large (e.g. above a threshold size). Modelling a large area is likely to lead to problems such as sparse matrices and features being correlated that the principles described herein seek to address. Accordingly, if the area is deemed to be large, then the algorithm continues to operation 64; otherwise the algorithm 60 terminates at operation 59, where an alternative method is used.

At operation 64, a determination is made regarding whether a number of features in the feature matrix is above a threshold level (i.e. is large). If not, then the algorithm moves to operation 66. If the number of features is deemed to be large, then it is determined that an alternative dimension reduction algorithm (e.g. PCA) should be used; accordingly, the algorithm 60 terminates at operation 59.

At operation 66, a determination is made regarding whether a number of data points of the feature matrix is above a second threshold level (i.e. is large). If so, the algorithm moves to operation 58, wherein the model is updated. If not, the algorithm 60 terminates at operation 59.

The, using the algorithm 60, the model of the system is updated in the event that the system being modelled covers a large area, the data size is large, but the feature size is moderate or low. Of course, the operations 62, 64 and 66 could be implemented in any order (including in parallel) and other factors may be considered in addition to, or instead of, one or more of the area, data size and features size.

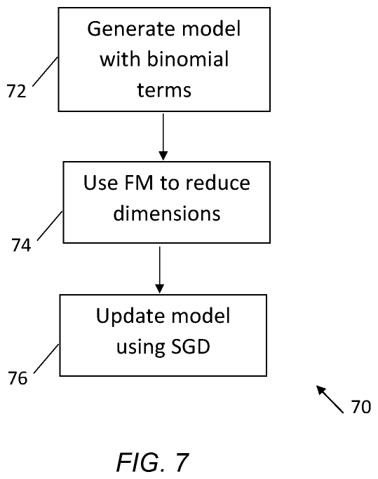

FIG. 7 is a flow chart showing an algorithm, indicated generally by the reference numeral 70, in accordance with an example embodiment. The algorithm 70 is an example implementation of the operation 58 described above.

The algorithm 70 starts at operation 72, where a model of the system (e.g. the system 10) is generated using binomial terms.

As binomials can express features correlation, we use it in hypothesis:

$$\\ \begin{matrix}y ( X ) = {ω}_{0} + {\sum }_{i = 1}^{n} {ω}_{i} {x}_{i} + {\sum }_{i = 1}^{n - 1} {\sum }_{j = i + 1}^{n} {ω}_{ij} {x}_{i} {x}_{j} & ( 1 )\end{matrix}$$

where n is number of features, xᵢ is value of the ith feature, wᵢ is the ith feature's parameter on monomial, wᵢⱼ is the ith and jth features' parameter on binomial. Training the binomial parameter wᵢⱼ can be difficult because in a sparse matrix most training samples have xᵢxⱼ=0 (so that a non-zero gradient cannot be obtained in order to update wij). If only a few samples with xᵢxⱼ!=0 are available, this may not be sufficient to train the parameter.

At operation 74, a factorisation machine is used to reduce the dimensions of the model, as discussed further below. The operation 74 may generate a reduced dimension binomial expression model comprising the binomial expression of the system (as generated in the operation 62) factorised into an approximate product of two matrices.

The operation 74 may be implemented as follows.

First, we decompose W=transpose(V)*V, the ith column of V is defined as the ith feature's hidden vector and wᵢⱼ can be presented by inner product of Vᵢ and Vⱼ, therefore it turns to train Vᵢ=(vᵢ₁, vᵢ₂, vᵢ₃, . . . , vᵢₖ), where k is the length of hidden vector, the process is shown as below:

$$\\ {W}^{{}^{} *} = [ \begin{matrix}{ω}_{11} & {ω}_{12} & ⋯ & {ω}_{1 n} \\ {ω}_{21} & {ω}_{22} & ⋯ & {ω}_{2 n} \\ ⋯ & ⋯ & ⋯ & ⋯ \\ {ω}_{n 1} & {ω}_{n 2} & ⋯ & {ω}_{nn}\end{matrix} ] = {V}^{T} V = [ \begin{matrix}{V}_{1} \\ {V}_{2} \\ ⋯ \\ {V}_{n}\end{matrix} ] \times [ {V}_{1} , {V}_{2} , … , {V}_{n} ] = [ \begin{matrix}{v}_{11} & {v}_{12} & ⋯ & {v}_{1 k} \\ {v}_{21} & {v}_{22} & ⋯ & {v}_{2 k} \\ ⋯ & ⋯ & ⋯ & ⋯ \\ {v}_{n 1} & {v}_{n 2} & ⋯ & {v}_{nk}\end{matrix} ] \times [ \begin{matrix}{v}_{11} & {v}_{21} & ⋯ & {v}_{n 1} \\ {v}_{12} & {v}_{22} & ⋯ & {v}_{n 2} \\ ⋯ & ⋯ & ⋯ & ⋯ \\ {v}_{1 k} & {v}_{2 k} & ⋯ & {v}_{nk}\end{matrix} ]$$

This reduces the binomial training parameter number from n*(n−1)/2 to n*k and usually k<<n. Vᵢ can be trained as long as any combined feature value multiplying xᵢ is not o, therefore sparse problem is solved. After using a factorisation machine process, the Equation 1 can be expressed as:

$$\\ \begin{matrix}\hat{y} ( X ) := {ω}_{0} + {\sum }_{i = 1}^{n} {ω}_{i} {x}_{i} + {\sum }_{i = 1}^{n - 1} {\sum }_{j = i + 1}^{n} < {v}_{i} , {v}_{j} > {x}_{i} {x}_{j} & ( 2 )\end{matrix}$$

$$\\ < {v}_{i} , {v}_{j} > := {\sum }_{f = 1}^{k} {v}_{i , f} \cdot {v}_{j , f}$$

$$\\ \begin{matrix}{\sum }_{i = 1}^{n 1} {\sum }_{j = i + 1}^{n} < {v}_{i} , {v}_{j} > {x}_{i} {x}_{j} = \frac{1}{2} {\sum }_{i = 1}^{n} {\sum }_{j = 1}^{n} < {v}_{i} , {v}_{j} > {x}_{i} {x}_{j} - \frac{1}{2} {\sum }_{i = 1}^{n} < {v}_{i} , {v}_{i} > {x}_{i} {x}_{i} \\ = \frac{1}{2} ( {\sum }_{i = 1}^{n} {\sum }_{j = 1}^{n} {\sum }_{f = 1}^{k} {v}_{i , f} {v}_{j , f} {x}_{i} {x}_{j} - {\sum }_{i = 1}^{n} {\sum }_{f = 1}^{k} {v}_{i , f} {v}_{i , f} {x}_{i} {x}_{i} ) \\ = \frac{1}{2} {\sum }_{f = 1}^{k} [ ( {\sum }_{i = 1}^{n} {v}_{i , f} {x}_{i} ) \cdot ( {\sum }_{j = 1}^{n} {v}_{j , f} {x}_{j} ) - {\sum }_{i = 1}^{n} {v}_{i , f}^{{}^{} 2} {x}_{i}^{{}^{} 2} ] \\ = \frac{1}{2} {\sum }_{f = 1}^{k} [ {( {\sum }_{i = 1}^{n} {v}_{i , f} {x}_{i} )}^{2} - {\sum }_{i = 1}^{n} {v}_{i , f}^{{}^{} 2} {x}_{i}^{{}^{} 2} ]\end{matrix}$$

At operation 76 of the algorithm 70, the model is updated using stochastic gradient descent (SGD). For example the parameters of the model may be updated using a Softmax cost function.

For example, by using stochastic gradient descent to derive gradients from the Equation 2 above, we can write:

$$\\ \begin{matrix}\frac{\partial \hat{y} ( x )}{\partial θ} = \{ \begin{matrix}1 , & if θ is {ω}_{0} \\ {x}_{i} , & if θ is {ω}_{i} \\ {x}_{i} {\sum }_{j = 1}^{n} {v}_{j , f} {x}_{j} - {v}_{i , f} {x}_{i}^{{}^{} 2} & if θ is {v}_{i , f}\end{matrix} & ( 3 )\end{matrix}$$

We can then use a Softmax cost function for multi-class problem in a manner well known in the art.

Finally, the derivative chain rule can be used with Equation 3 to derive final gradients for each parameters, which can be used to update the model.

Thus, an approach is provided to address data sparsity and high correlation issues. The approach is based on a Softmax regression model with binomials using Factorization Machine (FM) principles.

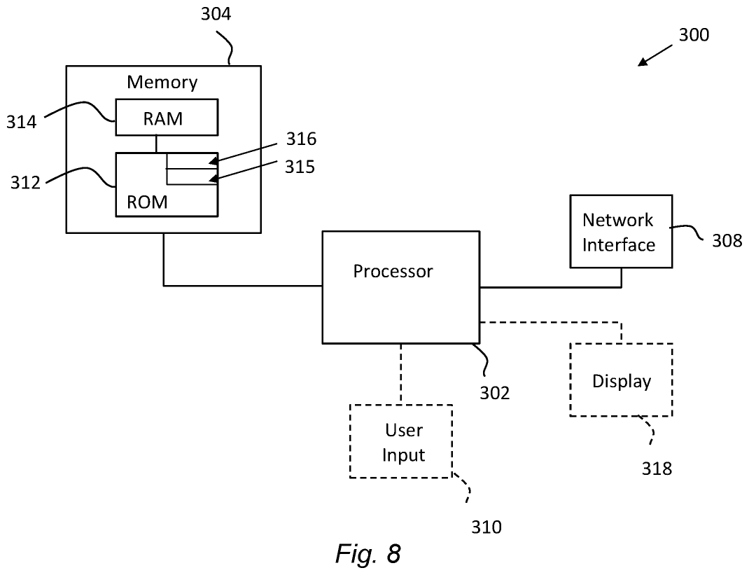

For completeness, FIG. 8 is a schematic diagram of components of one or more of the example embodiments described previously, which hereafter are referred to generically as a processing system 300. The processing system 300 may, for example, be the apparatus referred to in the claims below.

The processing system 300 may have a processor 302, a memory 304 closely coupled to the processor and comprised of a RAM 314 and a ROM 312, and, optionally, a user input 310 and a display 318. The processing system 300 may comprise one or more network/apparatus interfaces 308 for connection to a network/apparatus, e.g. a modem which may be wired or wireless. The network/apparatus interface 308 may also operate as a connection to other apparatus such as device/apparatus which is not network side apparatus. Thus, direct connection between devices/apparatus without network participation is possible.

The processor 302 is connected to each of the other components in order to control operation thereof.

The memory 304 may comprise a non-volatile memory, such as a hard disk drive (HDD) or a solid state drive (SSD). The ROM 312 of the memory 304 stores, amongst other things, an operating system 315 and may store software applications 316. The RAM 314 of the memory 304 is used by the processor 302 for the temporary storage of data. The operating system 315 may contain code which, when executed by the processor implements aspects of the algorithms 40, 50, 60 and 70 described above. Note that in the case of small device/apparatus the memory can be most suitable for small size usage i.e. not always a hard disk drive (HDD) or a solid state drive (SSD) is used.

The processor 302 may take any suitable form. For instance, it may be a microcontroller, a plurality of microcontrollers, a processor, or a plurality of processors.

The processing system 300 may be a standalone computer, a server, a console, or a network thereof. The processing system 300 and needed structural parts may be all inside device/apparatus such as IoT device/apparatus i.e. embedded to very small size.

In some example embodiments, the processing system 300 may also be associated with external software applications. These may be applications stored on a remote server device/apparatus and may run partly or exclusively on the remote server device/apparatus. These applications may be termed cloud-hosted applications. The processing system 300 may be in communication with the remote server device/apparatus in order to utilize the software application stored there.

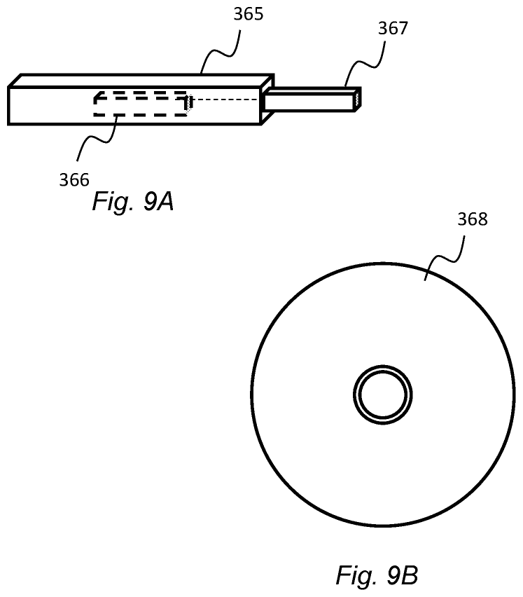

FIGS. 9A and 9B show tangible media, respectively a removable memory unit 365 and a compact disc (CD) 368, storing computer-readable code which when run by a computer may perform methods according to example embodiments described above. The removable memory unit 365 may be a memory stick, e.g. a USB memory stick, having internal memory 366 storing the computer-readable code. The internal memory 366 may be accessed by a computer system via a connector 367. The CD 368 may be a CD-ROM or a DVD or similar. Other forms of tangible storage media may be used. Tangible media can be any device/apparatus capable of storing data/information which data/information can be exchanged between devices/apparatus/network.

Embodiments of the present invention may be implemented in software, hardware, application logic or a combination of software, hardware and application logic. The software, application logic and/or hardware may reside on memory, or any computer media. In an example embodiment, the application logic, software or an instruction set is maintained on any one of various conventional computer-readable media. In the context of this document, a “memory” or “computer-readable medium” may be any non-transitory media or means that can contain, store, communicate, propagate or transport the instructions for use by or in connection with an instruction execution system, apparatus, or device, such as a computer.

Reference to, where relevant, “computer-readable medium”, “computer program product”, “tangibly embodied computer program” etc., or a “processor” or “processing circuitry” etc. should be understood to encompass not only computers having differing architectures such as single/multi-processor architectures and sequencers/parallel architectures, but also specialised circuits such as field programmable gate arrays FPGA, application specify circuits ASIC, signal processing devices/apparatus and other devices/apparatus. References to computer program, instructions, code etc. should be understood to express software for a programmable processor firmware such as the programmable content of a hardware device/apparatus as instructions for a processor or configured or configuration settings for a fixed function device/apparatus, gate array, programmable logic device/apparatus, etc.

If desired, the different functions discussed herein may be performed in a different order and/or concurrently with each other. Furthermore, if desired, one or more of the above-described functions may be optional or may be combined. Similarly, it will also be appreciated that the flow diagrams of FIGS. 4 to 7 are examples only and that various operations depicted therein may be omitted, reordered and/or combined.

It will be appreciated that the above described example embodiments are purely illustrative and are not limiting on the scope of the invention. Other variations and modifications will be apparent to persons skilled in the art upon reading the present specification.

Moreover, the disclosure of the present application should be understood to include any novel features or any novel combination of features either explicitly or implicitly disclosed herein or any generalization thereof and during the prosecution of the present application or of any application derived therefrom, new claims may be formulated to cover any such features and/or combination of such features.

Although various aspects of the invention are set out in the independent claims, other aspects of the invention comprise other combinations of features from the described example embodiments and/or the dependent claims with the features of the independent claims, and not solely the combinations explicitly set out in the claims.

It is also noted herein that while the above describes various examples, these descriptions should not be viewed in a limiting sense. Rather, there are several variations and modifications which may be made without departing from the scope of the present invention as defined in the appended claims.

1. An apparatus comprising:
at least one processor; and
at least one memory
storing instructions that, when executed by the at least one processor, cause the apparatus at least to:
collect mobile communication fingerprint data for signals between a user device and a plurality of communication nodes of a mobile communication system;
organize the collected data into a feature matrix, wherein the feature matrix includes a user device location associated with each set of fingerprint data;
generate a binomial expression of the system based on the collected data;
process the binomial expression to generate a reduced dimension binomial expression model; and
calculate gradients and update parameters of the reduced dimension binomial expression model based on said gradients.

2. An apparatus as claimed in claim 1, wherein said mobile communication fingerprint data comprises one or more of: reference signal receiving power, time of arrival and angle of arrival data at the user device.

3. An apparatus as claimed in claim 1, wherein said user device location is based on ground truth data.

4. An apparatus as claimed in claim 1, wherein said user device location is a discrete area.

5. An apparatus as claimed in claim 1, wherein the reduced dimension binomial expression model comprises the binomial expression of the system factorised into an approximate product of two matrices.

6. An apparatus as claimed in claim 1, wherein said gradients are calculated using stochastic gradient descent.

7. An apparatus as claimed in claim 1, wherein the at least one processor and the at least one memory storing instructions that, when executed by the at least one processor, cause the apparatus to update said parameters by using a softmax cost function.

8. An apparatus as claimed in claim 1, wherein said at least one processor and said at least one memory storing instructions that, when executed by the at least one processor, cause the apparatus to update said gradient until a defined condition is reached.

9. An apparatus as claimed in claim 1, wherein the at least one processor and the at least one memory storing instructions that, when executed by the at least one processor, cause the apparatus further to:
determine whether a number of features in the feature matrix is above a first threshold level and, if so, using an alternative dimension reduction algorithm instead of said factorisation machine.

10. An apparatus as claimed in claim 1, wherein the at least one processor and the at least one memory storing instructions that, when executed by the at least one processor, cause the apparatus further to:
determine whether a number of data points in the feature matrix is above a second threshold level and generate said binomial expression in the event that that the number of data points is above said second threshold level.

11. An apparatus as claimed in claim 1, wherein the at least one processor and the at least one memory storing instructions that, when executed by the at least one processor, cause the apparatus to process said binomial expression to generate said reduced dimension binomial expression comprises a factorisation machine.

12. A method comprising:
collecting mobile communication fingerprint data for signals between a user device and a plurality of communication nodes of a mobile communication system;
organising the collected data into a feature matrix, wherein the feature matrix includes a user device location associated with each set of fingerprint data;
generating a binomial expression of the system based on the collected data;
processing the binomial expression to generate a reduced dimension binomial expression model; and
calculating gradients and updating parameters of the reduced dimension binomial expression model based on said gradients.

13. A method as claimed in clam 12, wherein the reduced dimension binomial expression model comprises the binomial expression of the system factorised into an approximate product of two matrices.

14. A method as claimed in claim 12, wherein the binomial expression is processed to generate said reduced dimension binomial expression using a factorisation machine.

15.-17. (canceled)

18. A non-transitory computer readable medium comprising program instructions that, when executed by an apparatus, cause the apparatus to perform at least the following:
collect mobile communication fingerprint data for signals between a user device and a plurality of communication nodes of a mobile communication system;
organise the collected data into a feature matrix, wherein the feature matrix includes a user device location associated with each set of fingerprint data;
generate a binomial expression of the system based on the collected data;
processing the binomial expression to generate a reduced dimension binomial expression model; and
calculating gradients and updating parameters of the reduced dimension binomial expression model based on said gradients.

19. (canceled)

20. A method as claimed in claim 12, wherein said mobile communication fingerprint data comprises one or more of: reference signal receiving power, time of arrival and angle of arrival data at the user device.

21. A method as claimed in claim 12, wherein said user device location is based on ground truth data.

22. A method as claimed in claim 12, wherein said user device location is a discrete area.

23. A method as claimed in claim 12, wherein said gradients are calculated using stochastic gradient descent.

24. A method as claimed in claim 12, wherein updating said parameters comprises using a softmax cost function.
